(19) United States
(12) Patent Application Publication
(10) Pub. No.: US 2012/0082948 A1
(43) Pub. Date: Apr. 5, 2012

(54) MASK, METHOD AND APPARATUS FOR FORMING SELECTIVE EMITTER OF SOLAR CELL

(75) Inventors: Yun-Sung Huh, (US); Seung-II Park, (US)

(73) Assignee: SNT. Co., Ltd., Hwaseong (KR)

(21) Appl. No.: 13/221,441

(22) Filed: Aug. 30, 2011

(30) Foreign Application Priority Data
Sep. 30, 2010 (KR) KR10-2010-0095562

(51) Int. Cl. F27D 3/00; B32B 3/10

(52) U.S. Cl. 432/239; 428/131

(57) ABSTRACT

The present invention discloses a method and an apparatus for forming a selective emitter of a solar cell. The apparatus for forming a selective emitter of a solar cell in accordance with the embodiment of the present invention includes: a transport means configured to transport a substrate having a first emitter layer formed on an upper surface thereof, the first emitter layer having n-type impurities diffused and formed therein, a table configured to be supplied with the substrate from the transport means and to support the supplied substrate, a mask, being placed on the upper side of the first emitter layer and having a patterned opening, and a ramp, being located above the table and applying a heat energy to the first emitter layer that is exposed though the mask.

### CROSS-REFERENCE TO RELATED APPLICATIONS

This application claims the benefit of Korean Patent Application No. 10-2010-0095562, filed with the Korean Intellectual Property Office on Sep. 30, 2010, the disclosure of which is incorporated herein by reference in its entirety.

### TECHNICAL FIELD

The present invention relates to a mask, a method and an apparatus for forming a selective emitter of a solar cell.

### BACKGROUND OF THE INVENTION

As environmental pollution problems become increasingly serious, there have recently been a number of studies for renewable energy that can reduce the environmental pollution. Particularly, much attention has been paid to solar cells that can produce electrical energy by use of solar energy. However, in order to utilize the solar cells in actual industries, the photoelectric transformation efficiency of the solar cell needs to be sufficiently high, and the cost of manufacturing the solar cell needs to be low.

From the perspective of photoelectric transformation efficiency, there is a limit to increasing the photoelectric transformation efficiency of an actual solar cell because the theoretical efficiency limit of the solar cell is not very high, but it has been reported by world-renowned research groups that the silicon solar cell currently has a photoelectric transformation efficiency of 24% or higher.

Nonetheless, in case of mass-producing the solar cells, the actual average photoelectric transformation efficiency of the solar cell is hardly higher than 17%. Accordingly, there have been demands for a high-efficiency manufacturing method that can be applied in automated mass-production lines with the annual capacity of 30 MW or more.

### DISCLOSURE

### Technical Problem

The present invention provides a method and an apparatus for forming a selective emitter of a solar cell that can improve the photoelectric transformation efficiency of the solar cell by forming the selective emitter and can form the selective emitter in a stable manner.

### SUMMARY OF INVENTION

An aspect of the present invention features an apparatus for forming a selective emitter of a solar cell, which includes: a transport means configured to transport a substrate having a first emitter layer formed on an upper surface thereof, the first emitter layer having n-type impurities diffused and formed therein, a table configured to be supplied with the substrate from the transport means and to support the supplied substrate, a mask, being placed on the upper side of the first emitter layer and having a patterned opening, and a ramp, being located above the table and applying a heat energy to the first emitter layer that is exposed though the mask.

Another aspect of the present invention features a method for forming a selective emitter of a solar cell, which includes: preparing a substrate having a first emitter layer formed on an upper surface thereof, the first emitter layer having n-type impurities diffused and formed therein, placing a mask having a patterned opening on the upper side of the first emitter layer, and applying a heat energy to the first emitter layer that is exposed through the mask, and forming a second emitter layer in which the n-type impurities are further diffused and formed.

The pre-heating means can pre-heat the substrate through the table, and the pre-heating means pre-heats the substrate through the table.

The transport means comprises a conveyor belt, and the table is placed on a lower side of the conveyor belt. The apparatus for forming a selective emitter of a solar cell can also include a substrate sensor placed at a front side of the table and configured to sense transfer of the substrate and to control the operation of the conveyor belt such that the substrate is placed and stops over the table.

A negative pressure hole for supplying negative pressure can be formed in the table in order to prevent the substrate placed over the table from moving.

The opening that is formed on the mask can include: a first area that is formed at the location corresponding to the location of finger electrode that will be formed in the substrate, and a second area that is formed at the location corresponding to the location of bus bar electrode that will be formed in the substrate.

A pattern of grid shape is formed in the second area, and the widths of grid and the first area are equal.

The mask can include a transparent substrate; and a metal film, being coupled to a bottom surface of the transparent substrate and having patterned opening. In addition, the first lens configured to concentrate energy into the first area can be formed on the transparent substrate, and the second lens configured to concentrate energy into the second area can be formed on the transparent substrate.

The ramp can include a plurality of ramps and a ramp housing, which supports the plurality of ramps, and a curved concave surface can be formed on a lower surface of the ramp housing. In addition, the ramp housing can have a cooling device installed therein, and the ramp is movable.

Still another aspect of the present invention features a mask of forming a selective emitter of a solar cell, which includes: a transparent substrate; and a metal film, being coupled to a bottom surface of the transparent substrate and having patterned opening, wherein the opening that is formed on the mask includes: a first area that is formed at the location corresponding to the location of finger electrode that will be formed in the substrate; and a second area that is formed at the location corresponding to the location of bus bar electrode that will be formed in the substrate, wherein a first lens configured to concentrate energy into the first area is formed on the transparent substrate.

The second lens configured to concentrate energy into the second area can be formed on the transparent substrate.

### Advantageous Effects

A preferred embodiment of the present invention can improve the photoelectric transformation efficiency of a solar cell by forming a selective emitter and can form a selective emitter in a stable and efficient manner.

### DESCRIPTION OF DRAWINGS

FIG. 1 is a flow diagram illustrating a method for forming a selective emitter of a solar cell in accordance with an aspect of the present invention.

FIG. 2 and FIG. 3 illustrate coating impurities on a surface of a substrate.

FIG. 4 illustrates applying heat energy to the substrate in order to form a first emitter layer.

FIG. 5 is a cross-sectional view illustrating the substrate on which the first emitter layer is formed.

FIG. 6a illustrates one embodiment of using a ramp to form a second emitter layer.

FIG. 6b illustrates another embodiment of using a ramp to form a second emitter layer.

FIG. 7 is a cross-sectional view of the substrate in which the second emitter layer is formed.

FIGS. 8 and 9 are graphs illustrating the change in diffusion coefficient according to temperature.

FIG. 10 is a plan view illustrating how a bus bar layer and a finger layer are formed.

FIG. 11 is a plan view illustrating how a bus bar electrode and a finger electrode are formed.

FIG. 12 is an enlarged view of one portion of mask.

FIGS. 13-15 illustrate various alternatives of method for forming a selective emitter of a solar cell in accordance with an aspect of the present invention.

FIG. 16 is a cross-sectional view illustrating one embodiment of mask.

FIGS. 17 and 18 are a cross-sectional view illustrating another embodiment of mask.

FIG. 19 is a perspective view illustrating one embodiment of an apparatus for forming a selective emitter of a solar cell in accordance with another aspect of the present invention.

FIG. 20 is a perspective view illustrating one embodiment of an apparatus for forming a selective emitter of a solar cell in accordance with another aspect of the present invention.

FIG. 21 is a plan view of a transport assembly.

FIG. 22 is a perspective view of a table assembly.

FIG. 23 is a plan view illustrating FIG. 22 with the table removed.

FIG. 24 is a side view of the table assembly.

### MODE FOR INVENTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, certain preferred embodiments of a mask, a method and an apparatus for forming a selective emitter of a solar cell in accordance with the present invention will be described in detail with reference to the accompanying drawings. Identical or corresponding elements will be given the same reference numerals, regardless of the figure number, and any redundant description of the identical or corresponding elements will not be repeated. illustrates a pre-heating means 300 for this pre-heating process. The pre-heating process will be described below in detail.

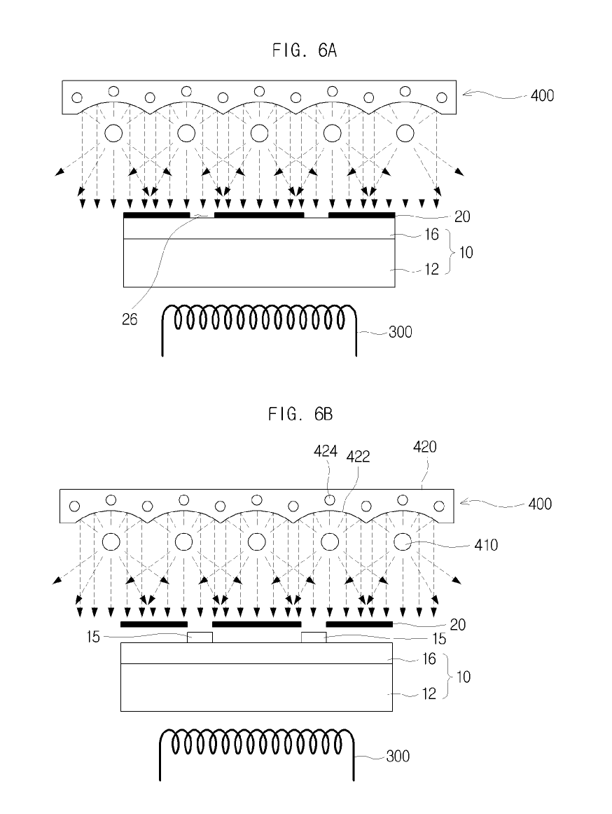

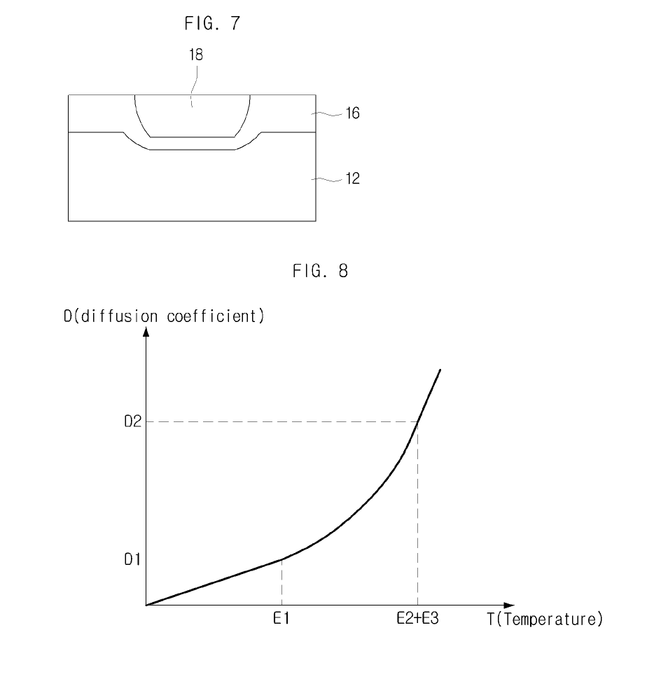

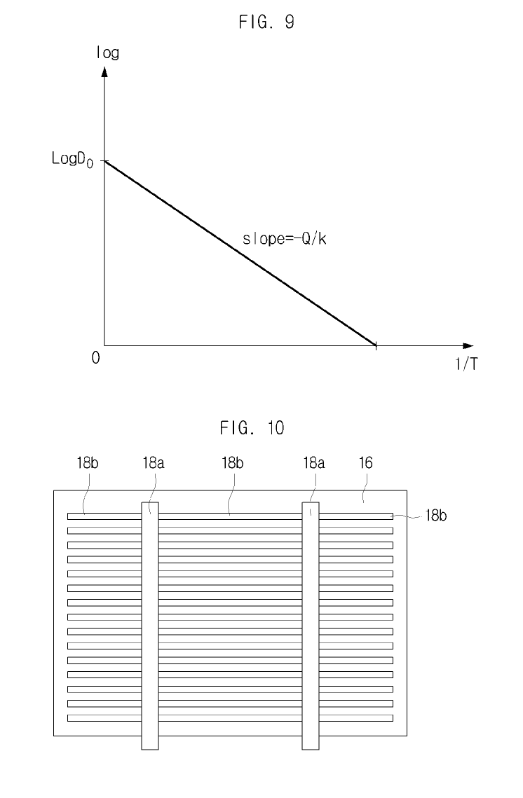

Then, as shown in FIG. 6, a mask having patterned opening 26 is placed over the upper side of the first emitter layer 16 (S200), and then a heat energy is applied to the first emitter layer 16 that is exposed through the mask 20, and the second emitter layer 18 (see FIG. 7), in which the n-type impurities 12 are further diffused and formed, is formed (S300). In other words, the heat energy is applied by use of the mask 20 and a ramp 400 selectively to a portion of the first emitter layer 14, in which the n-type impurities 14 are already diffused.

As described above, when performing the pre-heating process, the sum of energy E3 applied to the substrate 10 by pre-heating and energy E2 applied by the ramp 400 needs to be greater than the energy E1 used for forming the first emitter layer 14 (E2+E3>E1).

By proceeding with the pre-heating process separately from supply of heat energy by the ramp 400, it is possible to reduce the difference in energy between an area to which the heat energy is applied and the rest area to prevent the substrate 10 from being damaged. Here, the pre-heating process and the heat energy applied by the ramp 400 process can be performed successively or simultaneously.

A method for forming a selective emitter of a solar cell in accordance with an aspect with the present invention will be described first with reference to FIG. 1 to FIG. 7.

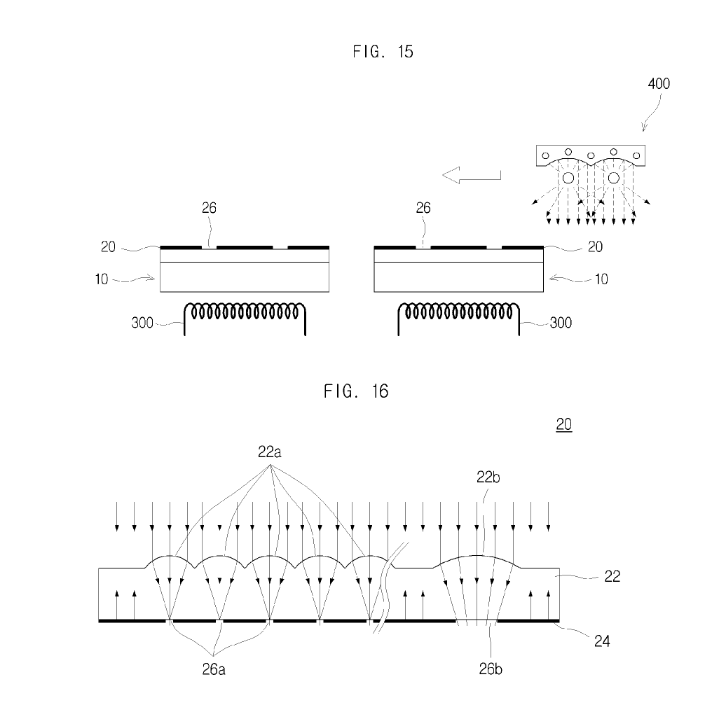

First, a substrate 10, on which a first emitter layer 16 having n-type impurities 14 diffused and formed therein is formed on an upper surface thereof, is prepared (S100). Here, the substrate 10 can be mounted over a table 200 (shown in FIG. 13). When processing the forming of the selective emitter while the substrate 10 is fixed on the table 200, the selective emitter can be formed in a stable manner without generating vibrations on the substrate 10.

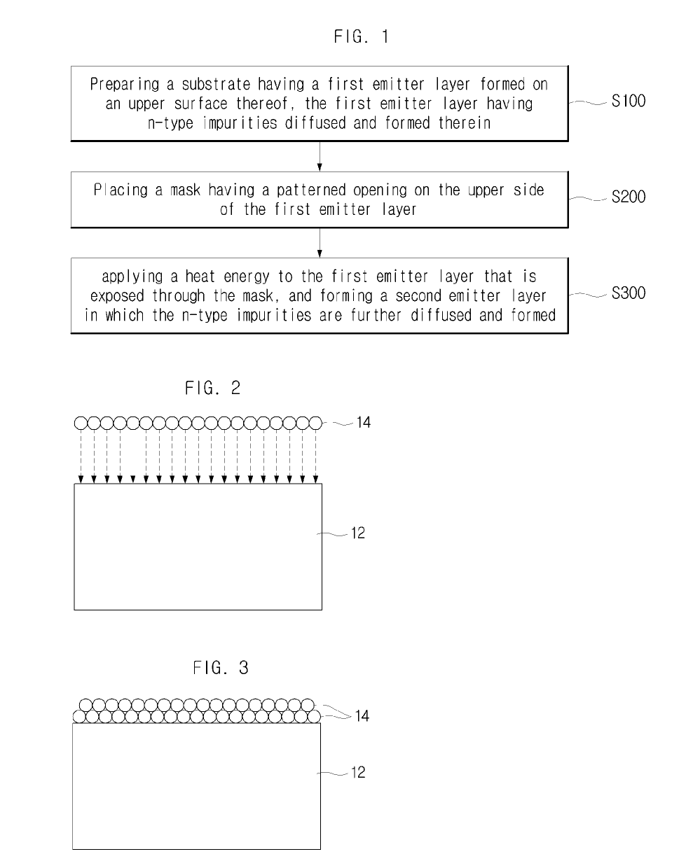

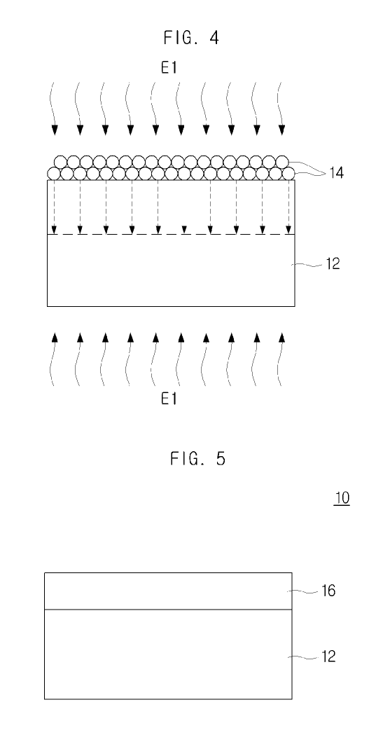

To fabricate this substrate 10, n-type impurities such as phosphor can be coated on a top surface of p-type silicon wafer 12 in which boron ions are doped (see FIGS. 2 and 3), and then the silicon wafer 12 can be applied with heat energy E1 (see FIG. 4). When the heat energy E1 is applied to the silicon substrate 10, ions of the impurities 14 can be diffused into the silicon substrate 10 and the first emitter layer 16 can be formed (see FIG. 5). Here, the first emitter layer 16 corresponds to an n-layer having the impurities 14, such as phosphor, diffused and formed.

It is possible to perform a pre-heating process for applying a certain amount of heat energy to the entire substrate on which the first emitter layer 16 is formed. FIG. 6a

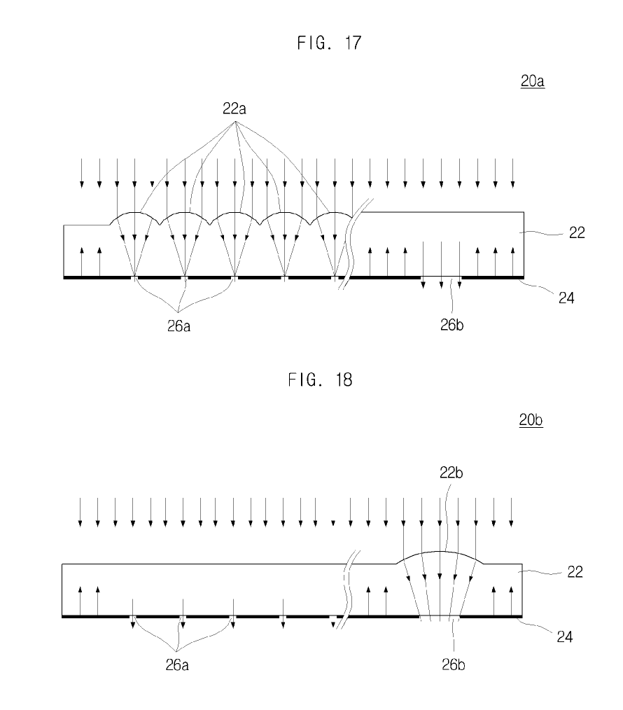

When energy E2+E3 that is greater than the energy E1 used for forming the first emitter layer 16 is applied to a portion of the first emitter layer 16 through pre-heating and supply of heat energy by the ramp 400 as described above, the n-type impurities 14 are further diffused in the portion where the heat energy is applied, and as a result, the second emitter layer 18 can be formed in the portion of the first emitter layer 16 (see FIG. 17).

In order to prepare the case that the concentration of impurities of the already formed n layer, that is, the first emitter layer 16 is insufficient, as shown in FIG. 6b, it is also possible to supply the heat energy after further forming an additional n-type impurities 15 in the position in which the second emitter layer 18 will be formed.

Hereinafter, the principle of forming the second emitter layer 18 will be described below in detail.

When atoms within a solid are not concentrated uniformly, the atoms within the solid are diffused by thermal motion from high-concentration areas to low-concentration areas until the concentration of the atoms becomes uniform throughout the solid. The diffusion phenomenon based on Fick's first law of diffusion, in which the amount of diffusion is proportional to a concentration gradient, can be expressed in the following equation.

$$J = - D \frac{\partial C}{\partial x} \qquad [ Equation 1 ]$$

In [Equation 1], J is an amount of diffusion (i.e., an amount of diffusion material passing through a unit area), and D is a diffusion coefficient. C is a concentration of the diffusion material, and x is a movement distance of the diffusion material on the Y-axis.

Here, the diffusion coefficient increases radically as the temperature increases, and this can be expressed in the following equation.

D=D₀e^{-Q/kT} [Equation 2]

In [Equation 2], D₀ is a constant that is not sensitive to temperature, and k is a Boltzmann constant while T is a temperature. Q, which is referred to as activation energy, has a value between 2 and 5 eV, depending on the material. The change of diffusion coefficient per temperature according to [Equation 2] is illustrated in graphs shown in FIGS. 8 and 9. For example, when Q=2 eV and D₀=8×10-5 m²/sec, D is approximately 10-38 m²/sec at 300° K, but D is dramatically increased to 10-11 m²/sec when T=1500° K.

Therefore, as shown in FIG. 8, if it is supposed that the energy E1 and the energy E2+E3 that have different temperatures from each other are respectively supplied to two different points of the silicon wafer 12, the levels where the impurities 14 reach become different because the diffusion coefficients of the two points are respectively D1 and D2, which are different from each other (i.e., the diffusion coefficient increases with the increasing temperature), and thus the second emitter layer 18 is formed in a certain portion of the first emitter layer 16, distinguishing the two emitter layers from each other, as shown in FIG. 7.

As shown in FIG. 9, the graph shown in FIG. 8 can be redrawn in a graph indicating a reciprocal relation between a log function and temperature. The following equation is the log function corresponding to the graph shown in FIG. 9 that is expressed from [Equation 2].

$$Log D = - \frac{Q}{kT} + Log {D}_{0} \qquad [ Equation 3 ]$$

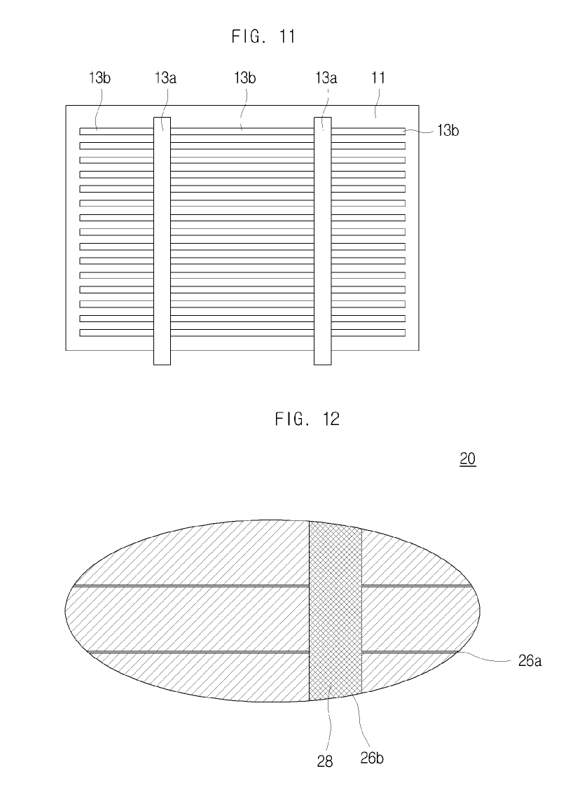

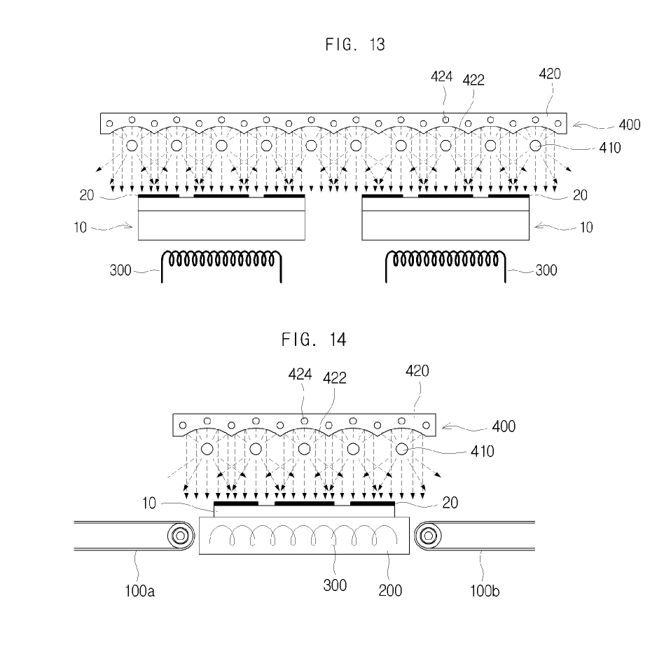

As illustrated in FIG. 10, the second emitter layer 18 selectively formed on the first emitter layer 16 can include bus bar layers 18a, which are formed at locations where bus bar electrodes 13a (see FIG. 11) of the solar cell are to be formed, and finger layers 16b, which are formed at locations where finger electrodes 13b (see FIG. 11) are to be formed. In order to form all of the bus bar layers 18a and finger layers 18b, the openings 26 that are formed on the mask 20 can comprise, as shown in FIG. 12, the first area 26a that is formed at the location corresponding to the location of finger electrode 13b that will be formed in the substrate 10, and the second area 26b that is formed at the location corresponding to the location of bus bar electrode 13a that will be formed in the substrate 10. By using the mask 20 having openings 26 comprising all of the first area 26a and the second area 26b, the bus bar layer 18a and the finger layer 18b can be formed simultaneously by one time supply of heat energy by use of the ramp 400.

In the openings 26a, 26b that are formed in the mask 20 to be used for the selective emitter of solar cell, the width of the first area 26a corresponding to the finger electrode 13b is about 50˜150 μm and the width of the second area 26b corresponding to the bus bar electrode 13a is about 1.5˜3.0 mm.

FIG. 11 shows that the finger electrodes 13b are formed on the finger layers 18b (see FIG. 10) and the bus bar electrodes 13a are formed on the bus bar layer 18a (see FIG. 10). The areas excluding where the finger electrodes 13b and the bus bar electrodes 13a are formed are formed with a reflection prevention film 11.

It is preferable that the amounts of heat energy per unit area that is supplied to the substrate 10 through the first area 26a and the second area 26b are uniform. But, the amount of heat energy that is supplied to the substrate 10 will be increased when the open area is increased. It is because the heat energy applied to the substrate 10 may spread along with the bottom surface of the mask 20 in a side direction.

When considering this phenomenon, according to this embodiment, as shown in FIG. 12, by inserting an additional pattern such as grid 28 to the second area 26b, the difference in heat energy applied to the unit area between the first area 26a and the second area 26b can be minimized. Here, if the widths of grid 28 and the first area 26a are designed to be equal, the difference will be further minimized.

FIGS. 13 through 15 illustrate various alternatives of method for forming a selective emitter of a solar cell in accordance with an aspect of the present invention. In FIG. 13, when a plurality of substrates 10 is arranged in parallel, one ramp 400 applies the heat energy to the plurality of substrates 10 simultaneously.

FIG. 14 illustrates forming a selective emitter in an inline method by continuously providing the substrate 10 through conveyor belts 100a, 100b, and placing the ramp 400 based on the location where the substrate 10 is temporarily stopped.

In FIG. 15, when a plurality of substrates 10 is arranged in parallel, one ramp 400 is moving to individually apply the heat energy to each substrate 10.

As being understood by FIGS. 13-15, it will be easily appreciated that the arrangement of the substrate 10 and the ramp 400 can be changed variously as occasion demands.

As shown in FIGS. 13 and 14, the ramp 400 may comprise a plurality of ramps 410 of emitting ultraviolet ray and so on and a ramp housing 420 arranged on an upper side of the ramp 410 and formed with a curved concave surface 422 on a lower surface thereof. The curved concave surface 422 formed in the ramp housing 420 can function as a reflecting plate for reflecting the heat energy emitted by the ramp in direction toward the substrate. Since the ramp housing 420 may be overheated due to the continuous work, the ramp housing 420 can have a cooling device 424 such as a coolant pipe.

FIG. 16 illustrates one embodiment of the mask 20. As illustrated in FIG. 16, the mask 20 can comprise a transparent substrate 22, and a metal film, coupled to a bottom surface of the transparent substrate 22, having patterned opening 26a, 26b (collectively, 26). In order to fabricate this mask 20, metal such as nickel or chrome is disposed one side of the transparent substrate 22 having light-penetrable components such as glass, quartz or similar components to form the metal film 24, and then the metal film 24 is etched in the desired pattern to form the openings 26a, 26b.

In order to reinforce the energy incident to the first area 26a in which the amount of energy that is applied to unit area is relatively small, the first lens 22a for concentrating energy into the first area 26a can be formed on the transparent substrate 22, and if necessary, the second lens 22b for concentrating energy into the second area 22b can also be formed. FIG. 16 illustrates both of the first lens 22a and the second lens 22b formed on the transparent substrate 22.

As shown in FIG. 16, when both of the first lens 22a and the second lens 22b are formed on a single mask, the heat energy may not be properly applied to the portion in where the finger layer will be formed in the area where the bus bar layer 18a and the finger layer are crossed. In order to prevent this problem, as shown in FIGS. 17 and 18, the first mask 20a on which the first lens 22a only is formed and the second mask 20b on which the second lens 22b are separately prepared, and then the processes of forming the bus bar layer 18b and the finger layer 18a can be proceeded individually.

Hitherto, although the mask in which the transparent substrate 22 and the metal film 24 are integrated is provided, it is also possible to separately form the transparent substrate 22 and the metal film 24. In this case, the transparent substrate on which the first lens 22a is formed and the transparent substrate on which the second lens 22b is formed are prepared, and then the heat energy can be applied to each transparent substrate with one metal film 24 by changing the substrates.

In addition, the first lens 22a for bus bar and the second lens 22b for the finger are formed side by side in the same direction on one transparent substrate 22, and then the heat energy can be applied to the transparent substrate 22 by rotating the substrate 22 by 90 degrees each time.

As described above, when concentrating energy by forming the lens 22a, 22b on the transparent substrate 22, it is advantageous to more efficiently utilize the heat energy emitted from the ramp 400.

In addition, in order to equalize the amount of energy applied to the unit area, it is also possible to form a pattern such as grid 28 (see FIG. 12) in the second area 26 b as described above.

Hitherto, a method for forming a selective emitter of a solar cell in accordance with an aspect of the present invention has been described, and hereinafter, an apparatus for forming a selective emitter of a solar cell in accordance with another aspect of the present invention will be described. It is possible that the above-described method for forming a selective emitter of a solar cell is carried out by a same or similar apparatus as the below-described apparatus for forming a selective emitter of a solar cell. Therefore, it shall be appreciated that the description about the operation of each apparatus to be described below can be also applied in the above-described method for forming a selective emitter of a solar cell.

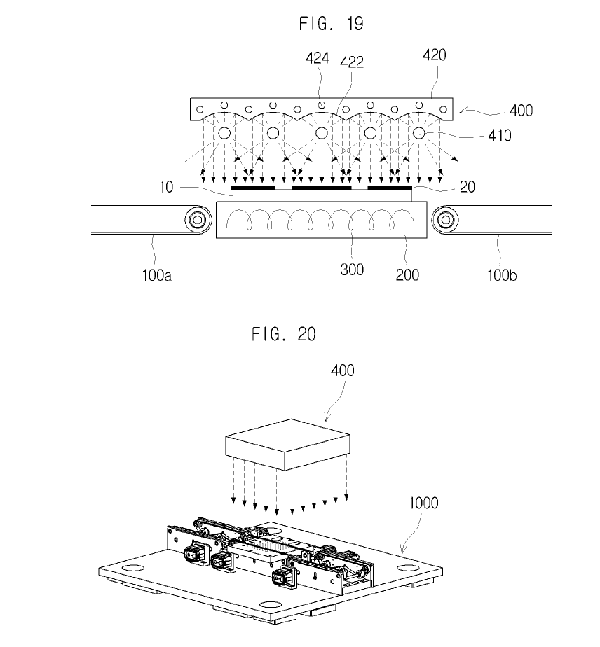

As illustrated in FIG. 19, the apparatus for forming a selective emitter of a solar cell in accordance with another aspect of the present invention is mainly constituted with: a transport means 100a, 100b, 100c (see FIG. 20) (collectively referred to as “100”) for transporting a substrate 10 on which a first emitter layer 16 (see FIG. 5) is formed on an upper side thereof; a table 200 for supporting the supplied substrate 10; a mask 20, being placed on the upper side of the first emitter layer 16 and having a patterned opening 26; and a ramp 400, being located above the table 200 and applying a heat energy to the first emitter layer 16 that is exposed though the mask 20.

The transport means 100 performs the function of supplying the substrate 10, on which the first emitter layer 16 is already formed, to the table 200. Although it is possible to use a robot arm or a turntable (not shown), which can perform a process by rotating with a substrate thereon, for such transport means 100, the present embodiment presents a conveyor belt, which is advantageous for continuous manufacturing. By implementing an in-line method that transports the substrate 10 by use of the conveyor belt as in the present embodiment, continuous processing becomes possible, and production yield can be improved.

The table 200 supports the substrate 10 supplied through the transport means 100, and the second emitter layer (18 in FIG. 7) is selectively formed on the substrate 10 while the substrate 10 is supported by the table 200. By selectively forming the second emitter layer 18 while the substrate 10 is fixed on the table 200, the selective emitter can be formed in a stable manner, without having vibrations occurred in the substrate 10.

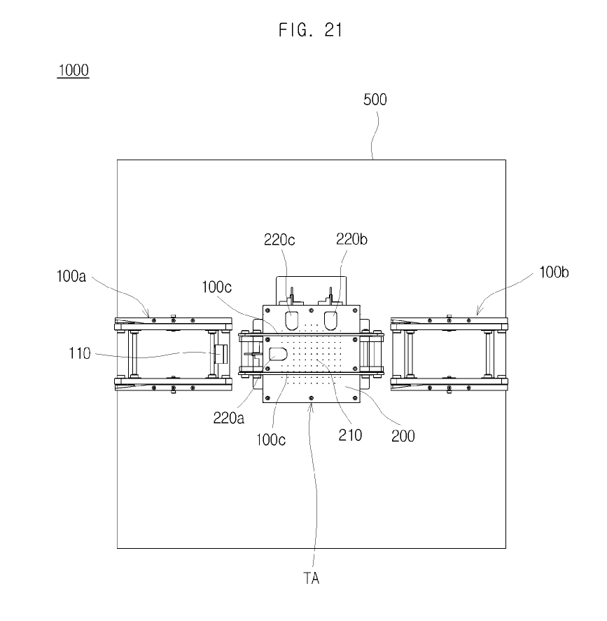

The above-described transport means 100 and table 200 can be constituted in a single assembly form, as shown in FIGS. 20 and 21, and such single assembly form will be referred to as a transport assembly 1000 herein. The specific structure of the transport assembly 1000 will be described later.

The substrate 10 supplied to the table 200 by the transport means 100 comprises a p-type silicon wafer 12 in which boron ions are doped, and the first emitter layer 14 is already formed on the upper side thereof. The process of preparing the substrate 10 on which the first emitter layer 16 is pre-formed is identical to the earlier description, and thus its specific description will not be provided herein.

The pre-heating means 300 performs the function of pre-heating the substrate 100 supported by the table 200. By applying a certain amount of energy E3 (see FIG. 8) to the entire substrate 10 through the pre-heating means 300 and supplying energy E2 (see FIG. 8) required in addition to the energy E3, which is supplied by the pre-heating, through the mask 20 and the ramp 400, the difference in energy between an area exposed by the mask 20 and areas not exposed by the mask 20 can be prevented from being excessive. Thus, as described earlier, the pertinent area of the substrate 10 can be prevented from being damaged by concentrating an excessive intensity of heat energy irradiated to the pertinent area of the substrate 10.

The pre-heating means 300 can pre-heat the substrate 10 through the table 200. That is, the pre-heating means 300 can heat the table 200 to have the heated table 200 to pre-heat the substrate 10. In such a case, as shown in FIG. 19, a heat coil embedded in the table 200 can be used as the pre-heating means 300.

While pre-heating the substrate 10 by way of the table 200 is described in the present embodiment, the present invention is not restricted to what is described in the present embodiment, and it shall be possible that a non-contact type of pre-heating means that can directly heat the substrate 10 can be used independently of the table 200.

The mask 20 is placed on the upper side of the substrate, and functions to expose the selected portion of the surface of the substrate. For this, as described earlier, the openings including the first area 26a and the second area 26b can be formed on the mask 20.

The ramp 400 is located over the table 200, and provides the hear energy to the substrate 10 being supported by the table 200. At a portion where the heat energy is applied by the ramp 400, the impurities are further diffused to allow the second emitter layer 18 (see FIG. 18) to be formed.

The second emitter layer 18 selectively formed on the first emitter layer 16 can include bus bar layers 18a, which are formed at locations where bus bar electrodes 13a (see FIG. 11) of the solar cell are to be formed, and finger layers 18b, which are formed at locations where finger electrodes 13b (see FIG. 11) are to be formed. In order to form all of the bus bar layers 16a and finger layers 16b, the openings 26 that are formed on the mask 20 can comprise the first area 26a that is formed at the location corresponding to the location of finger electrode 13b that will be formed in the substrate 10, and the second area 26b that is formed at the location corresponding to the location of bus bar electrode 13a that will be formed in the substrate 10. As this, when using the mask 20 having openings 26 comprising all of the first area 26a and the second area 26b, the bus bar layer 18a and the finger layer 18b can be formed simultaneously by one time supply of heat energy by use of the ramp 400. In addition, it is also possible to use masks 20a, 20b in FIGS. 17 and 18 as described above.

Hereinafter, the structure of the transport assembly 1000 will be described in more detail with reference to FIGS. 21 to 24.

The transport assembly 1000 is configured to be supplied with the substrate 10, support the substrate while the heat energy is applied by the ramp 400, and transfer the substrate 10 for which the heat energy is applied by the ramp 400 is completed to a following process. FIG. 16 shows the transport assembly 1000 that includes a table frame 500, which is generally in a plate shape, a front transport means 100a, which is placed on the table frame 500, a table assembly TA, and a rear transport means 100b.

The front transport means 100a performs the function of supplying the substrate 10 to the table assembly TA, and the rear transport means 100b performs the function of transferring the substrate 10, for which supply of heat energy is completed, to a following process. The table assembly TA performs is supplied with the substrate 10 from the front transport means 100a and performs the function of supporting the substrate 10 while heat energy is applied by the ramp 400 to the substrate 10. Here, a center transport means 100c is arranged on the table assembly TA.

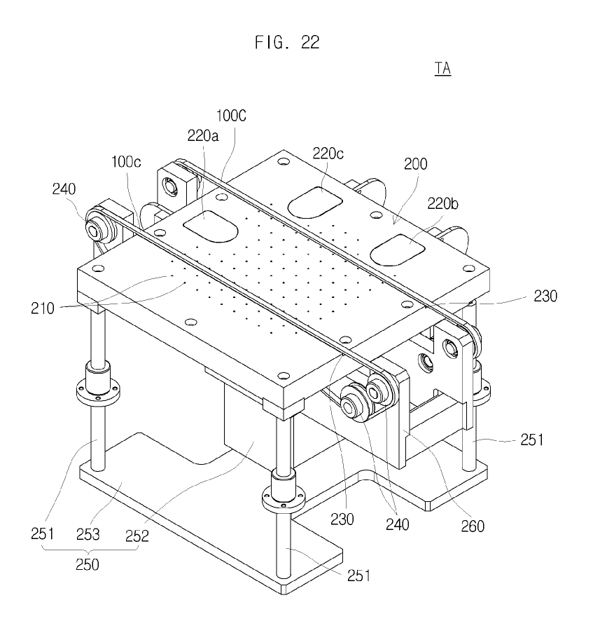

In the present embodiment, conveyor belts are used for the front transport means 100a, the rear transport means 100b, and the center transport means 100c. By implementing an in-line type that uses the conveyor belt, continuous processing becomes possible, and production yield can be improved. The center transport means 100c, which places the substrate 100 on the table 200, can be operated by being coupled to a belt frame 260 (see FIG. 22) having rollers 240 (see FIG. 22), etc.

As described above, if conveyor belts are used as the transport means 100 for placing the substrate 10 on the table 200, the table 200 can be arranged at a predetermined location below the center transport means 100c, i.e., the conveyor belt. However, the present invention is not restricted to this, and it is possible that the location of the table 200 is changed according to the structure of the transport means 100.

As illustrated in FIG. 21, a substrate sensor 110, which senses the transfer of the substrate 10, can be placed at a front side of the table 200. The substrate sensor 110 can perform the function of stopping the substrate 10 at a precise location on the table 200 by sensing the substrate 10 that is being transferred toward the table 200. To perform this function, the substrate sensor 110 can detect the transfer of the substrate 10 and then stop the operation of the conveyor belt 100 after an elapse of a predetermined time (e.g., 1.5 seconds).

The table 200 can have a groove 230 (see FIG. 22) formed on an upper surface thereof such that the conveyor belt 100c can be inserted in the groove 230. By forming the groove 230 in the table 200, the substrate 10 can be prevented from being unnecessarily separated from the table 200 by the conveyor belt 100c, making it possible to allow the table 200 to support the substrate 10 in a more stable way.

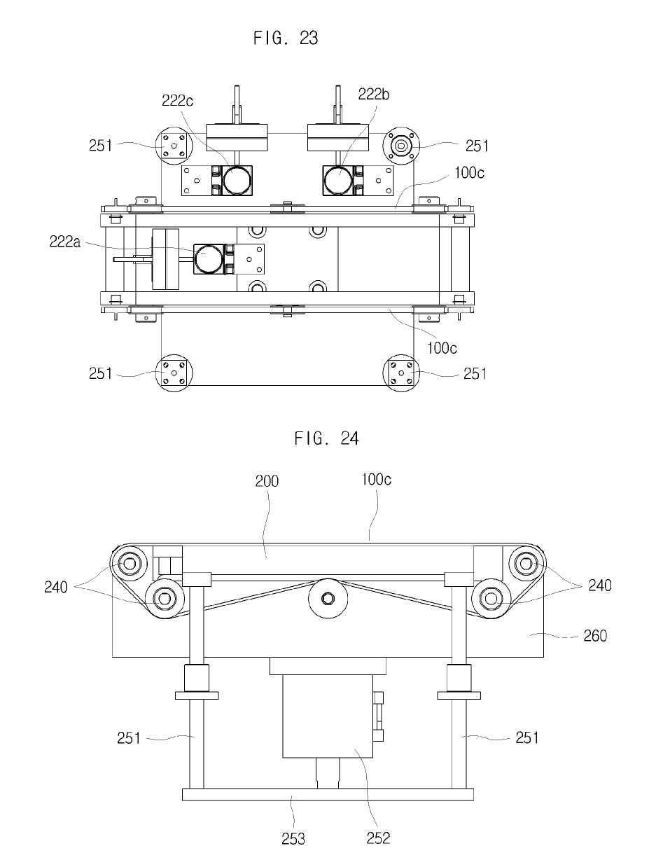

The apparatus for forming a selective emitter of a solar cell in accordance with the present embodiment can include alignment sensors 222a, 222b, 222c (collectively “222”; see FIG. 23), which sense an alignment state of the substrate 10 placed over the table 200. The alignment sensor 222 detects the alignment state of the substrate 10 placed over the table 200 in order to ensure the matching between the mask 20 and the substrate 10. The detected alignment state of the substrate 10 is sent to the mask 20, and positions of the mask 20 can be corrected based on the alignment state of the substrate 10.

For the alignment sensor 222, the present embodiment presents a camera and a lighting means placed below the table 200. For this, the table 200 can have transparent areas 220a, 220b, 220c (collectively “220”; see FIG. 22) such that the camera can sense the alignment state of the substrate 10. Here, it shall be understood that the transparent area 220 does not necessarily mean complete transparency but can be sufficiently translucent to optically sense the alignment state of the substrate 10. The transparent area 220 of the present embodiment is provided with quartz.

The alignment sensor 222 can include a first sensor 222a for sensing a back side of the substrate 10, a second sensor 222b for sensing a lateral side of the substrate 10, and a third sensor 222c for sensing a rotation state of the substrate 10. Accordingly, alignment errors in X-axis and Y-axis directions can be determined by sensing front and lateral side edges using the first sensor 222a and the second sensor 222b, and rotational alignment errors can be determined using the third sensor 222c.

Once the alignment state of the substrate 10 is sensed, the table 200 and the substrate 10 placed over the table 200 can be elevated by a table elevator 250 (see FIG. 22). The table elevator 250 performs the function of elevating and lowering the table 200 by a predetermined height. While the substrate 10 is elevated by the table elevator 250, supply of heat energy can be processed on the substrate 10.

The table elevator 250 can include: a plurality of supporting legs 251, which are arranged to be spaced from one another along the outer edges of the table 200 and are vertically extendible, and a cylinder 252 for vertically moving the belt frame 260. Each of the supporting legs 251 can be fixed to a support frame 253 for better assembly. Other power transfer structures that can be used for the table elevator 250 can include a linear actuator (not shown) and gear trains (not shown).

The table 200 can also have negative pressure holes 210 formed therein in order to prevent the substrate 10 placed over the table 200 from moving. By forming the negative pressure holes 210 in the table 200 and supplying negative pressure to a lower side of the substrate 10 using, for example, a pump (not shown), the substrate 10 becomes closely adhered to the table 200, preventing the alignment state of the substrate 10 from falling into disorder.

Hitherto, the structure of the apparatus for forming a selective emitter of a solar cell in accordance with another aspect of the present invention has been described, and an operation of the apparatus in accordance with an embodiment of the present invention will be described hereinafter.

Once the substrate 10 is supplied unto the table 200, the pre-heating means 300 supplies heat energy E2 to the substrate 10. The supplying of heat energy E2 can last until supply of heat energy by the ramp 400 is completed.

The alignment state of the substrate 10 placed over the table 200 is sensed by the alignment sensor 222, and then the table 10 on which the substrate 10 is placed is elevated.

The detected alignment state of the substrate 10 is transferred to the mask 20, and the position of the mask 20 is corrected according to the alignment state of the substrate 10.

If the mask 20 covers selectively the upper side of the substrate 10, the ramp 400 applies the heat energy to a portion of the substrate 10 which is selectively exposed through the mask to form the second emitter layer 18 (see FIG. 7).

Once supply of heat energy by the ramp 400 is completed, the table 200 is lowered back to its original position, and then the substrate 10 is transported for a following process.

Although certain preferred embodiments of the present invention have been described, it shall be appreciated that various modifications and permutations of the present invention are possible by those who are skilled in the art to which the present invention pertains without departing from the technical ideas and scope of the present invention.

It shall be also appreciated that there can be many other embodiments than the above described embodiments in the claims of the present invention.

What is claimed is:

1. An apparatus for forming a selective emitter of a solar cell, comprising:
a transport means configured to transport a substrate having a first emitter layer formed on an upper surface thereof, the first emitter layer having n-type impurities diffused and formed therein;
a table configured to be supplied with the substrate from the transport means and to support the supplied substrate;
a mask, being placed on the upper side of the first emitter layer and having a patterned opening; and
a ramp, being located above the table and applying a heat energy to the first emitter layer that is exposed though the mask.

2. The apparatus of claim 1 further comprising a pre-heating means configured to pre-heat the substrate supported by the table.

3. The apparatus of claim 1, wherein the pre-heating means pre-heats the substrate through the table.

4. The apparatus of claim 1, wherein the transport means comprises a conveyor belt, and
wherein the table is placed on a lower side of the conveyor belt.

5. The apparatus of claim 4 further comprising a substrate sensor placed at a front side of the table and configured to sense transfer of the substrate and to control the operation of the conveyor belt such that the substrate is placed and stops over the table.

6. The apparatus of claim 1, wherein a negative pressure hole for supplying negative pressure is formed in the table in order to prevent the substrate placed over the table from moving.

7. The apparatus of claim 1, wherein the opening that is formed on the mask comprises:
a first area that is formed at the location corresponding to the location of finger electrode that will be formed in the substrate; and
a second area that is formed at the location corresponding to the location of bus bar electrode that will be formed in the substrate.

8. The apparatus of claim 7, wherein the mask comprise:
a transparent substrate; and
a metal film, being coupled to a bottom surface of the transparent substrate and having patterned opening.

9. The apparatus of claim 8, wherein a first lens configured to concentrate energy into the first area is formed on the transparent substrate.

10. The apparatus of claim 9, wherein a second lens configured to concentrate energy into the second area is formed on the transparent substrate.

11. The apparatus of claim 7, wherein a pattern of grid shape is formed in the second area.

12. The apparatus of claim 11, wherein the widths of grid and the first area are equal.

13. The apparatus of claim 1, wherein the ramp comprises:
a plurality of ramps; and
a ramp housing, being located on an upper side of the ramp and having a curved concave surface formed on a lower surface thereof.

14. The apparatus of claim 13, wherein the ramp housing comprises a cooling device.

15. The apparatus of claim 1, wherein the ramp is movable.

16. A method for forming a selective emitter of a solar cell, comprising:
preparing a substrate having a first emitter layer formed on an upper surface thereof, the first emitter layer having n-type impurities diffused and formed therein;
placing a mask having a patterned opening on the upper side of the first emitter layer; and
applying heat energy to the first emitter layer that is exposed through the mask, and forming a second emitter layer in which the n-type impurities are further diffused and formed.

17. The method of claim 13 further comprising pre-heating the substrate before applying the heat energy to the first emitter layer.

18. The method of claim 16 further comprising, prior to placing the mask, further forming the n-type impurities on the first emitter layer corresponding to the opening.

19. The method of claim 16, wherein the opening that is formed on the mask comprises:
a first area that is formed at the location corresponding to the location of finger electrode that will be formed in the substrate; and
a second area that is formed at the location corresponding to the location of bus bar electrode that will be formed in the substrate.

20. The method of claim 19, wherein the mask comprise:
a transparent substrate; and
a metal film, being coupled to a bottom surface of the transparent substrate and having patterned opening.

21. The method of claim 19, wherein a first lens configured to concentrate energy into the first area is formed on the transparent substrate.

22. The method of claim 21, wherein a second lens configured to concentrate energy into the second area is formed on the transparent substrate.

23. The method of claim 18, wherein a pattern of grid shape is formed in the second area.

24. The method of claim 23, wherein the widths of grid and the first area are equal.

25. The method of claim 16, wherein the ramp comprises:
a plurality of ramps; and
a ramp housing configured to support the plurality of ramps,
wherein a curved concave surface is formed on a lower surface of the ramp housing.

26. The method of claim 25, wherein the ramp housing comprises a cooling device.

27. The method of claim 16, wherein the substrate is placed in the table on where a negative pressure hole is formed,
wherein supplying a negative pressure through the negative pressure hole in order to prevent the substrate placed over the table from moving.

28. A mask of forming a selective emitter of a solar cell, comprising:
a transparent substrate; and
a metal film, being coupled to a bottom surface of the transparent substrate and having patterned opening,
wherein the opening that is formed on the mask comprises:
a first area that is formed at the location corresponding to the location of finger electrode that will be formed in the substrate; and
a second area that is formed at the location corresponding to the location of bus bar electrode that will be formed in the substrate, wherein a first lens configured to concentrate energy into the first area is formed on the transparent substrate.

29. The mask of claim 28, wherein a second lens configured to concentrate energy into the second area is formed on the transparent substrate.

30. The mask of claim 28, wherein a pattern of grid shape is formed in the second area.

31. The mask of claim 30, wherein the widths of grid and the first area are equal.
